(19) United States
(12) Patent Application Publication
(10) Pub. No.: US 2011/0260971 A1
(43) Pub. Date: Oct. 27, 2011

(54) MULTI-FUNCTION MOUSE DEVICE

(75) Inventors: Chien-Nan Lin, Taipei (TW); Chun-Nan Su, Taipei (TW); Chin-Lung Lai, Taipei (TW); Jessica Jeng, Taipei (TW)

(73) Assignee: Primax Electronics Ltd., Taipei (TW)

(21) Appl. No.: 12/816,566

(22) Filed: Jun. 16, 2010

(30) Foreign Application Priority Data
Apr. 23, 2010 (TW) 099112835

(51) Int. Cl. G09G 5/08

(52) U.S. Cl. 345/163

(57) ABSTRACT

A multi-function mouse device includes a casing with a casing upper surface and a casing lateral surface, a first button disposed on the casing upper surface, a first sensing element, a second sensing element and a controlling unit. The first sensing element is disposed on the first button. The second sensing element is disposed on the casing lateral surface. By using a first finger of a user to trigger the second sensing element and moving the user's palm, the cursor shown on a computer monitor is controllable. Moreover, by using a first finger of a user to trigger the second sensing element, using a second finger of the user to trigger the first sensing element and moving the user's palm, a preset instruction is executed.

### FIELD OF THE INVENTION

The present invention relates to a mouse device, and more particularly to a multi-function mouse device.

### BACKGROUND OF THE INVENTION

With increasing development of science and technology, multimedia products and computers become essential in our daily lives. In the computer systems, input devices play important roles for communicating the computer host and the user. The common input devices include for example mice, keyboards or trackballs. Among these input devices, mice are the most prevailing because they are very easy-to-use. When a mouse is held on the palm of a user's hand, the user may move the mouse to control movement of the cursor shown on the computer screen. In addition, by manipulating the buttons of the mouse device, the user may point and click a desired icon shown on the computer monitor or execute a corresponding function.

Hereinafter, the configurations and the functions of a mouse device will be illustrated by referring to a wheel mouse device. FIG. 1 is a schematic diagram illustrating the connection between a conventional wheel mouse device and a computer system. The computer system 2 comprises a computer host 21 and a computer monitor 22. The computer host 21 is in communication with the wheel mouse device 1 and the computer monitor 22. A cursor 221 and a graphic-based window 222 are displayed on the computer monitor 22. The wheel mouse device 1 is used for controlling the cursor 221 such that the computer host 21 executes a corresponding instruction. The wheel mouse device 1 comprises a casing 10, a left button 11, a right button 12 and a scroll wheel 13. The casing 10 is used for supporting a user's palm. When the casing 10 is moved by the user to result in a displacement amount, the computer host 21 correspondingly moves the cursor 221 according to the displacement amount. By clicking the left button 11 or the right button 12, a control signal is issued to the computer host 21. In response to the control signal, the computer host 21 executes a corresponding instruction. By rotating the scroll wheel 13, the graphic-based window 222 shown on the computer monitor 21 may be scrolled upwardly or downwardly. The basic functions of the wheel mouse device have been described above.

From the above discussions, it is found that the conventional wheel mouse device has only the cursor control function. If the user wants to execute a specified instruction, the cursor needs to be firstly moved to a specified computer program icon, and then the icon is clicked to execute the specified instruction.

Moreover, for facilitating the user to conveniently input the instruction, two approaches applied to the input devices have been disclosed. In accordance with the first approach, a keyboard device with a specified function hotkey is provided. By pressing the specified function hotkey, the specified instruction is executed. In accordance with the second approach, a mouse device for implementing a specified function is provided. Regardless of whether the keyboard device or the mouse device for implementing the specified function is used, a driver should be previously installed in the computer host in order to execute the specified function. Take a mouse device having a specified function for example. Please refer to FIG. 1 again. A driver 211 is installed in the computer host 21. Once the driver 211 is activated, a specified function is achieved by operating the mouse device 1. For example, the graphic-based window 222 shown on the computer monitor 21 is an IE (Internet Explorer) web browser. If the driver 211 is not activated, the cursor 221 shown on the computer monitor 22 is controllable by moving the casing 10 of the mouse device 1. Whereas, if the driver 211 is activated and the computer system is operated with the IE software, a “Backward” function is implemented to have the browsing page go backward to the previous page by moving the casing 10 in the left direction; or a “Forward” function is implemented to have the browsing page go forward to the next page by moving the casing 10 in the right direction.

Although the driver is effective for expanding the functions of the mouse device, there are still some drawbacks. For example, if the user wants to use another computer host (i.e. other people's computer host) without installing the driver, the driver should be installed in order to operate the computer host via the mouse device. In other words, it is necessary for the user to carry the driver while installing the driver in other people's computer host. Since the user may carelessly forget to carry the driver or be unwilling to additionally carry the driver, the necessity of additionally carrying the driver is troublesome to the user.

Therefore, there is a need of providing a mouse device with specified function without the need of simultaneously carrying a driver.

### SUMMARY OF THE INVENTION

An object of the present invention provides a multi-function mouse device with multiple functions.

Another object of the present invention provides a multi-function mouse device without the need of installing a driver in a computer host.

In accordance with an aspect of the present invention, there is provided a multi-function mouse device in communication with a computer host for controlling a cursor shown on a computer monitor, which is in communication with the computer host. The multi-function mouse device includes a casing, a displacement sensing module, a first button, a second button, a first sensing element, a second sensing element and a controlling unit. The casing has a casing upper surface and a casing lateral surface. The displacement sensing module is disposed within the casing. The displacement sensing module generates a displacement amount signal in response to movement of the casing. The first button is disposed on the casing upper surface. The second button is disposed on the casing upper surface, and arranged beside the first button. The first sensing element is disposed on the first button. When the first sensing element is triggered, a first sensing signal is generated. The second sensing element is disposed on the casing lateral surface. When the second sensing element is triggered, a second sensing signal is generated. The controlling unit is connected with the first sensing element, the second sensing element and the displacement sensing module for receiving the first sensing signal, the second sensing signal and the displacement amount signal. When the second sensing signal and the displacement amount signal are received by the controlling unit, a cursor displacement signal is issued from the controlling unit to the computer host, and the computer host moves the cursor according to the cursor displacement signal. Whereas, when the first sensing signal, the second sensing signal and the displacement amount signal are received by the controlling unit, a preset function signal is issued from the controlling unit to the computer host, and the computer host executes a preset instruction according to the preset function signal.

In an embodiment, the multi-function mouse device further includes a scroll wheel protruded out of the casing upper surface. When the scroll wheel is rotated a scrolling signal is generated.

In an embodiment, the first button is a left button, the second button is a right button, and the first sensing element and the second sensing element are light sensors or capacitive touch pads.

In an embodiment, when the casing is moved in a first linear direction, the displacement sensing module generates the displacement amount signal corresponding to the first linear direction. According to the displacement amount signal corresponding to the first linear direction, the cursor displacement signal corresponding to the first linear direction is issued from the controlling unit, and the computer host moves the cursor in the first linear direction or executes the preset instruction corresponding to the first linear direction. The preset instruction corresponding to the first linear direction is executed to implement an IE web browser opening function, an IE software “Backward” function, an IE software “Forward” function or a frame-locking function.

In accordance with another aspect of the present invention, there is provided a multi-function mouse device in communication with a computer host for controlling a cursor shown on a computer monitor, which is in communication with the computer host. The multi-function mouse device includes a casing, a displacement sensing module, a first button, a second button, a first sensing element, a second sensing element and a controlling unit. The casing has a casing upper surface and a casing lateral surface. The displacement sensing module is disposed within the casing. The displacement sensing module generates a displacement amount signal in response to movement of the casing. The first button is disposed on the casing upper surface. The second button is disposed on the casing upper surface, and arranged beside the first button. The first sensing element is disposed on the first button. When the first sensing element is triggered, a first sensing signal is generated. The second sensing element is disposed on the casing lateral surface. When the second sensing element is triggered, a second sensing signal is generated. The controlling unit is connected with the first sensing element, the second sensing element and the displacement sensing module for receiving the first sensing signal, the second sensing signal and the displacement amount signal. When the first sensing signal, the second sensing signal and the displacement amount signal are received by the controlling unit, a cursor displacement signal is issued from the controlling unit to the computer host, and the computer host moves the cursor according to the cursor displacement signal. Whereas, the second sensing signal and the displacement amount signal are received by the controlling unit, a preset function signal is issued from the controlling unit to the computer host, and the computer host executes a preset instruction according to the preset function signal.

In an embodiment, the first button is a right button, the second button is a left button, and the first sensing element and the second sensing element are light sensors or capacitive touch pads.

In an embodiment, when the casing is moved in a first linear direction, the displacement sensing module generates the displacement amount signal corresponding to the first linear direction. According to the displacement amount signal corresponding to the first linear direction, the cursor displacement signal corresponding to the first linear direction is issued from the controlling unit, and the computer host moves the cursor in the first linear direction or executes the preset instruction corresponding to the first linear direction. The preset instruction corresponding to the first linear direction is executed to implement an IE web browser opening function, an IE software “Backward” function, an IE software “Forward” function or a frame-locking function.

In accordance with a further aspect of the present invention, there is provided a multi-function mouse device in communication with a computer host for controlling a cursor shown on a computer monitor, which is in communication with the computer host. The multi-function mouse device includes a casing, a displacement sensing module, a first button, a second button, a first sensing element, a second sensing element and a controlling unit. The casing has a casing upper surface and a casing lateral surface. The displacement sensing module is disposed within the casing. The displacement sensing module generates a displacement amount signal in response to movement of the casing. The first button is disposed on the casing upper surface. The second button is disposed on the casing upper surface, and arranged beside the first button. The first sensing element is disposed on the first button, and arranged beside the first button. When the first sensing element is triggered, a first sensing signal is generated. The second sensing element is disposed on the casing lateral surface. When the second sensing element is triggered, a second sensing signal is generated. The controlling unit is connected with the first sensing element, the second sensing element and the displacement sensing module for receiving the first sensing signal, the second sensing signal and the displacement amount signal. When the second sensing signal and the displacement amount signal are received by the controlling unit, a cursor displacement signal is issued from the controlling unit to the computer host, and the computer host moves the cursor according to the cursor displacement signal. Whereas, the first sensing signal, the second sensing signal and the displacement amount signal are received by the controlling unit, a preset function signal is issued from the controlling unit to the computer host, and the computer host executes a preset instruction according to the preset function signal.

In an embodiment, the first button is a left button, the second button is a right button, and the first sensing element and the second sensing element are light sensors or capacitive touch pads.

In an embodiment, when the casing is moved in a first linear direction, the displacement sensing module generates the displacement amount signal corresponding to the first linear direction. According to the displacement amount signal corresponding to the first linear direction, the cursor displacement signal corresponding to the first linear direction is issued from the controlling unit, and the computer host moves the cursor in the first linear direction or executes the preset instruction corresponding to the first linear direction. The preset instruction corresponding to the first linear direction is executed to implement an IE web browser opening function, an IE software “Backward” function, an IE software “Forward” function or a frame-locking function.

In accordance with a still aspect of the present invention, there is provided a multi-function mouse device in communication with a computer host for controlling a cursor shown on a computer monitor, which is in communication with the computer host. The multi-function mouse device includes a casing, a displacement sensing module, a first button, a second button, a first sensing element, a second sensing element and a controlling unit. The casing has a casing upper surface and a casing lateral surface. The displacement sensing module is disposed within the casing. The displacement sensing module generates a displacement amount signal in response to movement of the casing. The first button is disposed on the casing upper surface. The second button is disposed on the casing upper surface, and arranged beside the first button. The first sensing element is disposed on the first button, and arranged beside the first button. When the first sensing element is triggered, a first sensing signal is generated. The second sensing element is disposed on the casing lateral surface. When the second sensing element is triggered, a second sensing signal is generated. The controlling unit is connected with the first sensing element, the second sensing element and the displacement sensing module for receiving the first sensing signal, the second sensing signal and the displacement amount signal. When the first sensing signal, the second sensing signal and the displacement amount signal are received by the controlling unit, a cursor displacement signal is issued from the controlling unit to the computer host, and the computer host moves the cursor according to the cursor displacement signal. Whereas, when the second sensing signal and the displacement amount signal are received by the controlling unit, a preset function signal is issued from the controlling unit to the computer host, and the computer host executes a preset instruction according to the preset function signal.

In an embodiment, the first button is a right button, the second button is a left button, and the first sensing element and the second sensing element are light sensors or capacitive touch pads.

In an embodiment, when the casing is moved in a first linear direction, the displacement sensing module generates the displacement amount signal corresponding to the first linear direction. According to the displacement amount signal corresponding to the first linear direction, the cursor displacement signal corresponding to the first linear direction is issued from the controlling unit, and the computer host moves the cursor in the first linear direction or executes the preset instruction corresponding to the first linear direction. The preset instruction corresponding to the first linear direction is executed to implement an IE web browser opening function, an IE software “Backward” function, an IE software “Forward” function or a frame-locking function.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic diagram illustrating the connection between a conventional wheel mouse device and a computer system;

FIG. 2 is a schematic perspective view illustrating a multi-function mouse device according to a first embodiment of the present invention;

FIG. 3 is a schematic cross-sectional view illustrating the internal portion of the multi-function mouse device according to the first embodiment of the present invention;

FIG. 4 is a schematic diagram illustrating the connection between the multi-function mouse device of the first embodiment and a computer system;

FIG. 5 is a schematic diagram illustrating the use of the multi-function mouse device of the first embodiment to generate a cursor displacement signal;

FIG. 6 is a schematic diagram illustrating the use of the multi-function mouse device of the first embodiment to generate a preset function signal;

FIG. 7 is a schematic perspective view illustrating a multi-function mouse device according to a second embodiment of the present invention;

FIG. 8 is a schematic diagram illustrating the use of the multi-function mouse device of the second embodiment to generate a preset function signal;

FIG. 9 is a schematic diagram illustrating the use of the multi-function mouse device of the second embodiment to generate a cursor displacement signal;

FIG. 10 is a schematic perspective view illustrating a multi-function mouse device according to a third embodiment of the present invention;

FIG. 11 is a schematic diagram illustrating the use of the multi-function mouse device of the third embodiment to generate a cursor displacement signal;

FIG. 12 is a schematic diagram illustrating the use of the multi-function mouse device of the third embodiment to generate a preset function signal;

FIG. 13 is a schematic perspective view illustrating a multi-function mouse device according to a fourth embodiment of the present invention;

FIG. 14 is a schematic diagram illustrating the use of the multi-function mouse device of the fourth embodiment to generate a preset function signal; and

FIG. 15 is a schematic diagram illustrating the use of the multi-function mouse device of the fourth embodiment to generate a cursor displacement signal.

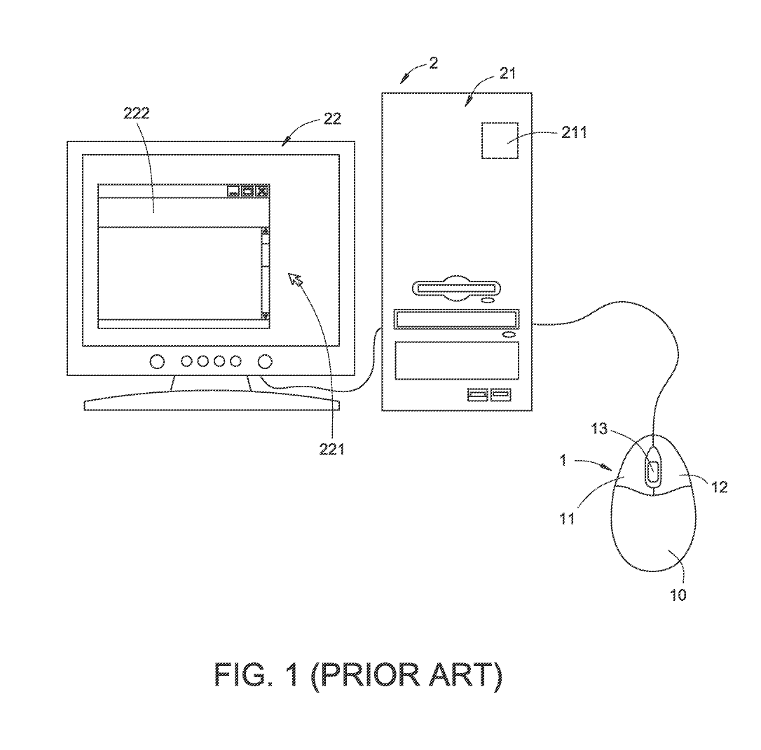

### DETAILED DESCRIPTION OF THE PREFERRED EMBODIMENT

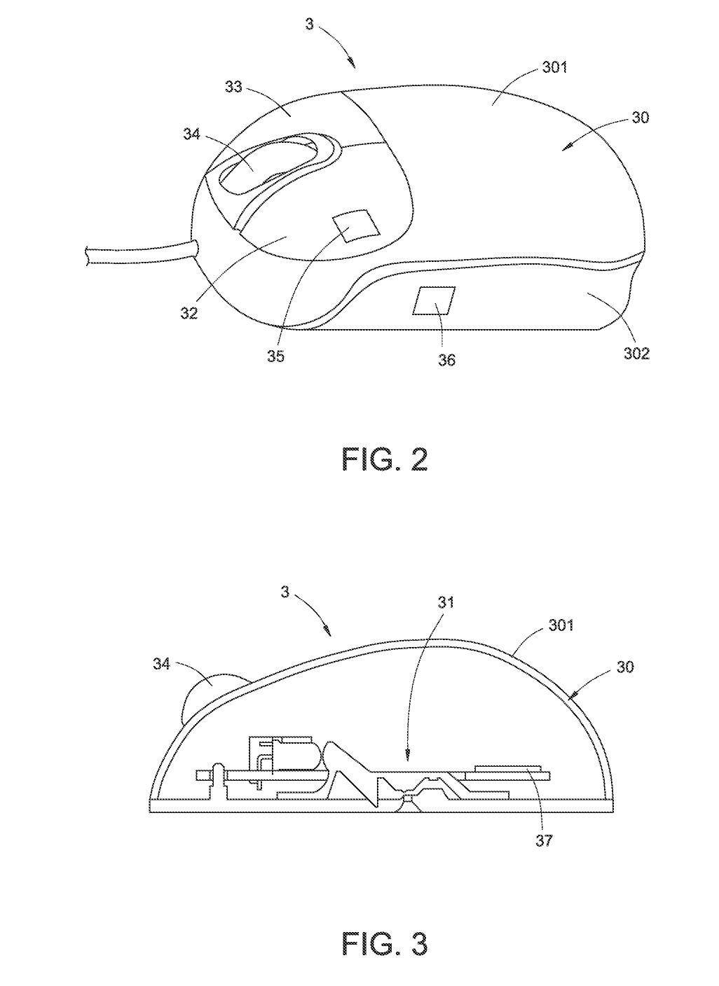

For obviating the drawbacks encountered from the prior art, the present invention provides a multi-function mouse device. FIG. 2 is a schematic perspective view illustrating a multi-function mouse device according to a first embodiment of the present invention. FIG. 3 is a schematic cross-sectional view illustrating the internal portion of the multi-function mouse device according to the first embodiment of the present invention. The multi-function mouse device 3 comprises a casing 30, a displacement sensing module 31 (see FIG. 3), a first button 32, a second button 33, a scroll wheel 34, a first sensing element 35, a second sensing element 36 and a controlling unit 37 (see FIG. 3). As shown in FIG. 2, the casing 30 has a casing upper surface 301 and a casing lateral surface 302. The first button 32 is disposed on the casing upper surface 301. The second button 33 is also disposed on the casing upper surface 301, and arranged beside the first button 32. The scroll wheel 34 is protruded out of the casing upper surface 301. By rotating the scroll wheel 34, a corresponding scrolling signal is generated. The first sensing element 35 is disposed on the first button 32. When the first sensing element 35 is triggered, a first sensing signal is generated. The second sensing element 36 is disposed on the casing lateral surface 302. When the second sensing element 36 is triggered, a second sensing signal is generated. In this embodiment, the first button 32 is a left button, and the second button 33 is a right button. Moreover, the first sensing element 35 and the second sensing element 36 are light sensors.

As shown in FIG. 3, the displacement sensing module 31 is disposed within the casing 30. When the casing 30 is moved, a corresponding displacement amount signal is generated. The controlling unit 37 is connected with the first sensing element 35, the second sensing element 36 and the displacement sensing module 31 through a printed circuit board. The first sensing signal, the second sensing signal and the displacement amount signal are received by the controlling unit 37. In this embodiment, the controlling unit 37 is a microprocessor.

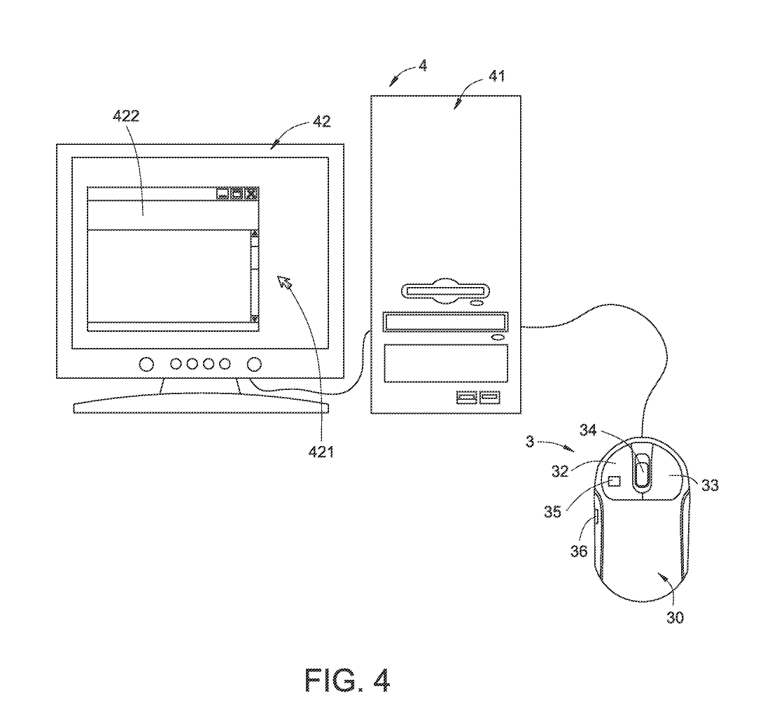

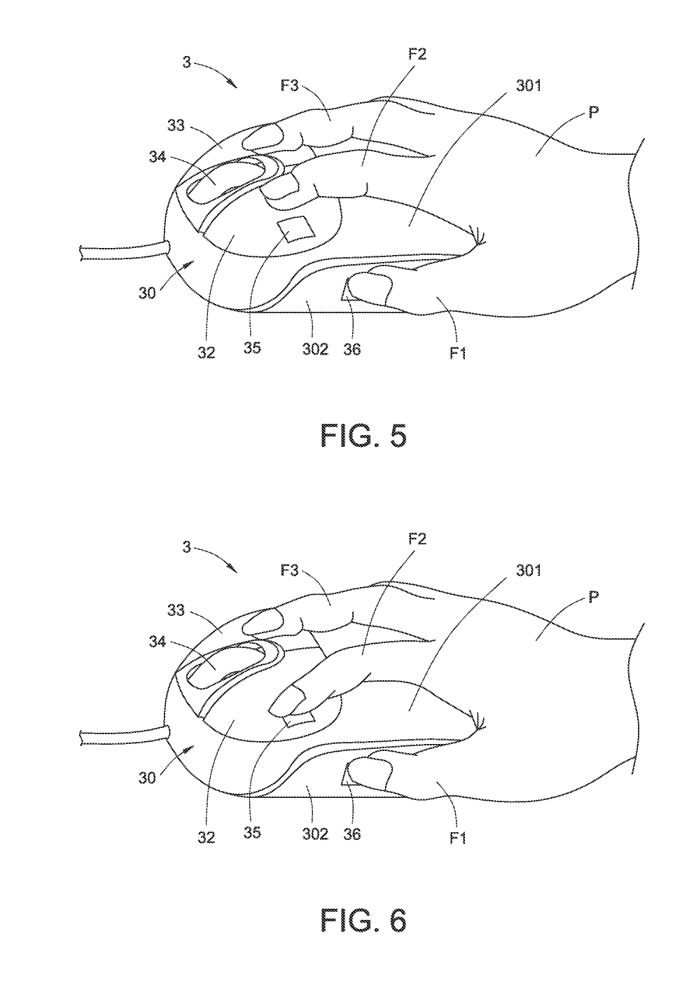

Please refer to FIGS. 4 and 5. FIG. 4 is a schematic diagram illustrating the connection between the multi-function mouse device of the first embodiment and a computer system. FIG. 5 is a schematic diagram illustrating the use of the multi-function mouse device of the first embodiment to generate a cursor displacement signal. As shown in FIG. 4, the computer system 4 comprises a computer host 41 and a computer monitor 42. The computer host 41 is in communication with the multi-function mouse device 3 and the computer monitor 42. A cursor 421 and a graphic-based window 422 are displayed on the computer monitor 42. In this embodiment, the graphic-based window 422 is an IE (Internet Explorer) web browser. For operating the computer system via the multi-function mouse device 3, the user's palm P is supported on the casing upper surface 301 of the casing 30. In addition, a first finger F1 is placed on the casing lateral surface 302 to trigger the second sensing element 36 on the casing lateral surface 302, a second finger F2 is placed on the first button 32 but is not contacted with the first sensing element 35 on the first button 32, and a third finger F3 is placed on the second button 33 (see FIG. 5).

Since the second sensing element 36 is triggered by the first finger F1, a second sensing signal is issued to the controlling unit 37. In addition, when the casing 30 is moved by the user's palm P in a first linear direction (e.g. the first linear direction is a left direction), a leftward displacement amount signal is issued from the displacement sensing module 31 to the controlling unit 37. When the second sensing signal and the displacement amount signal are received by the controlling unit 37, a leftward cursor displacement signal is issued from the controlling unit 37 to the computer host 41. According to the leftward cursor displacement signal, the computer host 41 moves the cursor 421 in the left direction.

It is noted that, the use of the second sensing element 36 is helpful for detecting whether the user's palm P is supported on the casing upper surface 301 of the casing 30, thereby judging whether the multi-function mouse device 3 is being used by the user. As a consequence, the possibility of erroneously operating the multi-function mouse device 3 will be minimized. For example, when the computer host 41 is temporarily in a non-usage status, if the multi-function mouse device 3 placed on a desk plane is touched to move by other objects, the displacement sensing module 31 may also issue a displacement amount signal to the controlling unit 37 in response to movement of the casing 30. However, since the second sensing element 36 is not triggered, no second sensing signal is generated. Since the second sensing signal and the displacement amount signal are not simultaneously received by the controlling unit 37, no cursor displacement signal is generated by the controlling unit 37 and the cursor 421 is not moved accordingly. The above cursor control functions of the multi-function mouse device 3 are similar to those of the common mouse device.

FIG. 6 is a schematic diagram illustrating the use of the multi-function mouse device of the first embodiment to generate a preset function signal. As shown in FIG. 6, the user's palm P is supported on the casing upper surface 301 of the casing 30. In addition, the first finger F1 is placed on the casing lateral surface 302 to trigger the second sensing element 36 on the casing lateral surface 302, the second finger F2 is placed on the first button 32 to trigger the first sensing element 35 on the first button 32, and the third finger F3 is placed on the second button 33. Since the first sensing element 35 and the second sensing element 36 are respectively triggered by the second finger F2 and the first finger F1, a first sensing signal and a second sensing signal are issued to the controlling unit 37. In addition, when the casing 30 is moved by the user's palm P in the left direction, a leftward displacement amount signal is issued from the displacement sensing module 31 to the controlling unit 37. When the first sensing signal, the second sensing signal and the displacement amount signal are received by the controlling unit 37, a leftward preset function signal is issued from the controlling unit 37 to the computer host 41. According to the preset function signal, the computer host 41 executes a preset instruction.

For example, the preset instruction is executed to implement an IE web browser opening function, an IE software “Backward” function, an IE software “Forward” function or a frame-locking function. In this embodiment, the forward preset instruction is executed to implement the IE web browser opening function; the rearward preset instruction is executed to implement the frame-locking function; the leftward preset instruction is executed to implement the IE software “Backward” function, and the rightward preset instruction is executed to implement the IE software “Forward” function. As described in FIG. 6, the computer host 41 executes the IE software “Backward” function according to the leftward preset function signal.

In this context, the linear direction includes a front direction, a rear direction, a left direction, a right direction or any of the 45-degree directions (i.e. the north-east direction, the south-west direction, the north-west direction and the south-east direction). The present invention is illustrated by referring to the preset instruction for implementing the common functions. Nevertheless, the present invention is not limited to these preset instructions.

Of course, the various hotkey instructions for the common keyboard device may be applied to the multi-function mouse device 3 of the present invention. For example, the sound volume control function may be implemented via the multi-function mouse device 3. When the first sensing signal, the second sensing signal and a leftward displacement amount signal are received by the controlling unit 37, a leftward preset function signal is issued from the controlling unit 37 to the computer host 41. According to the leftward preset function signal, the computer host 41 executes a preset instruction to implement a sound-decreasing function. Whereas, when the first sensing signal, the second sensing signal a rightward displacement amount signal are received by the controlling unit 37, a rightward preset function signal is issued from the controlling unit 37 to the computer host 41. According to the rightward preset function signal, the computer host 41 executes a preset instruction to implement a sound-increasing function.

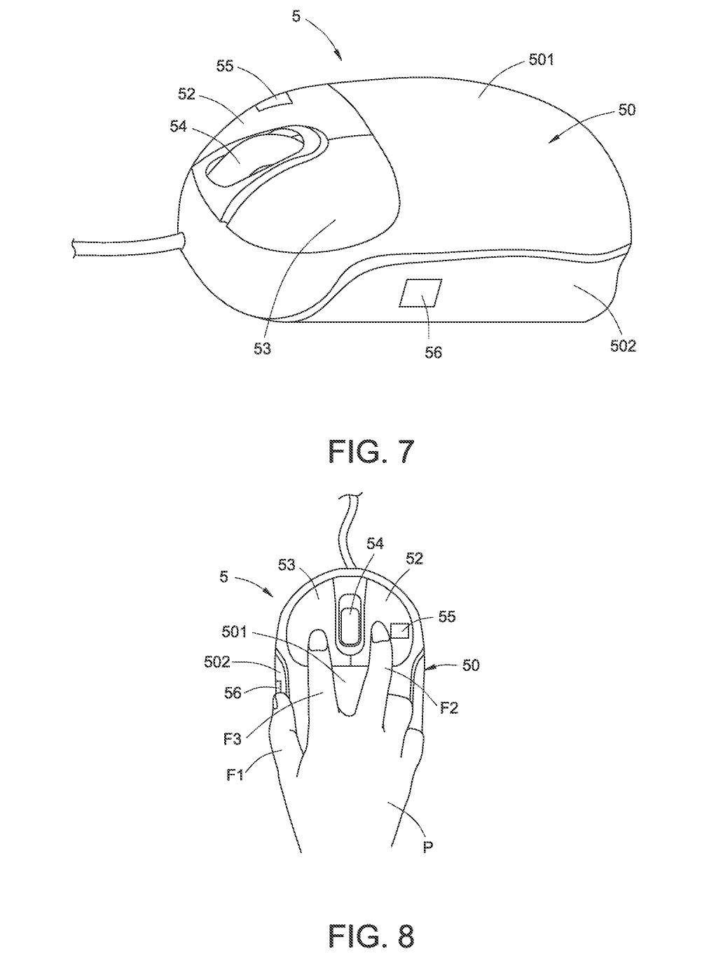

The present invention further provides a second exemplary multi-function mouse device. FIG. 7 is a schematic perspective view illustrating a multi-function mouse device according to a second embodiment of the present invention. The multi-function mouse device 5 comprises a casing 50, a displacement sensing module (not shown), a first button 52, a second button 53, a scroll wheel 54, a first sensing element 55, a second sensing element 56 and a controlling unit (not shown). The casing 50 has a casing upper surface 501 and a casing lateral surface 502. The first button 52 is disposed on the casing upper surface 501. The second button 53 is also disposed on the casing upper surface 501, and arranged beside the first button 52. The scroll wheel 54 is protruded out of the casing upper surface 501. By rotating the scroll wheel 54, a corresponding scrolling signal is generated. The first sensing element 55 is disposed on the first button 52. When the first sensing element 55 is triggered, a first sensing signal is generated. The second sensing element 56 is disposed on the casing lateral surface 502. When the second sensing element 56 is triggered, a second sensing signal is generated. In this embodiment, the first button 52 is a right button, and the second button 53 is a left button. Moreover, the first sensing element 55 and the second sensing element 56 are light sensors.

Like the multi-function mouse device 3 of the first embodiment, the multi-function mouse device 5 is also in communication with the computer system 4 for controlling movement of the cursor 421 shown on the computer monitor 42. For operating the computer system via the multi-function mouse device 5, the user's palm P is supported on the casing upper surface 501 of the casing 50. In addition, a first finger F1 is placed on the casing lateral surface 502 to trigger the second sensing element 56 on the casing lateral surface 502, a second finger F2 is placed on the first button 52 but is not contacted with the first sensing element 55 on the first button 52, and a third finger F3 is placed on the second button 53 (see FIG. 8).

Since the second sensing element 56 is triggered by the first finger F1, a second sensing signal is issued to the controlling unit. In addition, when the casing 50 is moved by the user's palm P in a first linear direction (e.g. the first linear direction is a right direction), a rightward displacement amount signal is issued from the displacement sensing module to the controlling unit. When the second sensing signal and the displacement amount signal are received by the controlling unit, a rightward preset function signal is issued from the controlling unit to the computer host 41. According to the rightward preset function signal, the computer host 41 executes a preset instruction. Like the first embodiment, the rightward preset instruction is executed to implement the IE software “Forward” function.

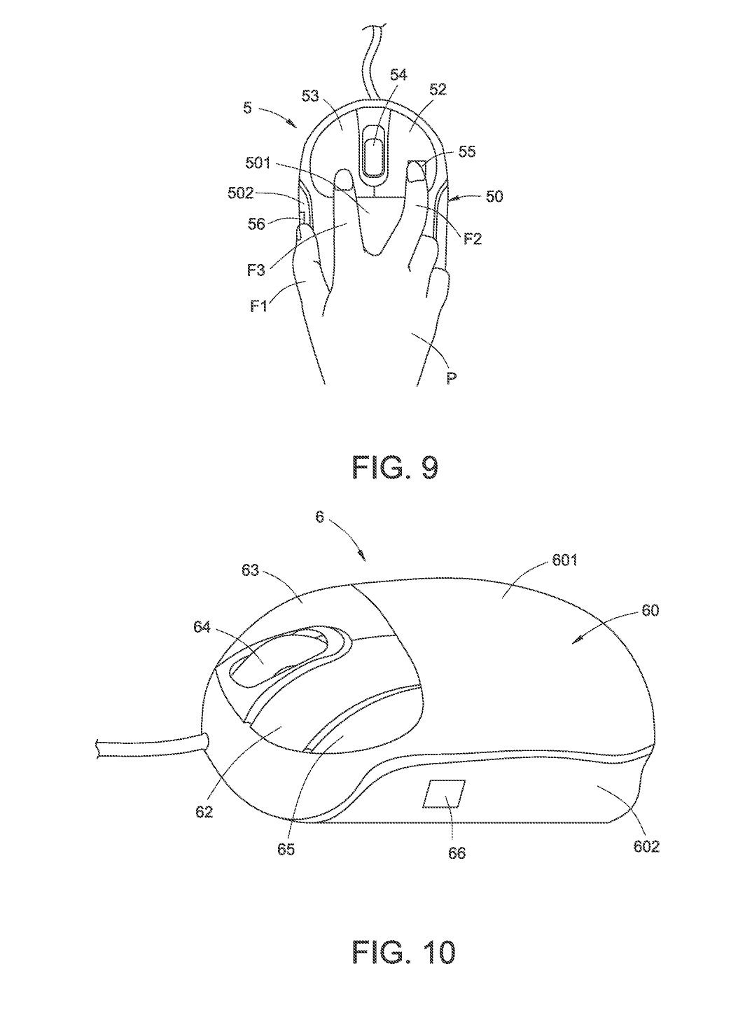

FIG. 9 is a schematic diagram illustrating the use of the multi-function mouse device of the second embodiment to generate a cursor displacement signal. As shown in FIG. 9, the user's palm P is supported on the casing upper surface 501 of the casing 50. In addition, the first finger F1 is placed on the casing lateral surface 502 to trigger the second sensing element 56 on the casing lateral surface 502, the third finger F3 is placed on the second button 53, and the second finger F2 is placed on and the first button 52 to trigger the first sensing element 55 on the first button 52. Since the first sensing element 55 and the second sensing element 56 are respectively triggered by the second finger F2 and the first finger F1, a first sensing signal and a second sensing signal are issued to the controlling unit. In addition, when the casing 50 is moved by the user's palm P in the right direction, a rightward displacement amount signal is issued from the displacement sensing module to the controlling unit. When the first sensing signal, the second sensing signal and the displacement amount signal are received by the controlling unit, a rightward cursor displacement signal is issued from the controlling unit to the computer host 41. According to the rightward cursor displacement signal, the computer host 41 moves the cursor 421 in the right direction.

The present invention further provides a third exemplary multi-function mouse device. FIG. 10 is a schematic perspective view illustrating a multi-function mouse device according to a third embodiment of the present invention. The multi-function mouse device 6 comprises a casing 60, a displacement sensing module (not shown), a first button 62, a second button 63, a scroll wheel 64, a first sensing element 65, a second sensing element 66 and a controlling unit (not shown). The casing 60 has a casing upper surface 601 and a casing lateral surface 602. The first button 62 is disposed on the casing upper surface 601. The second button 63 is also disposed on the casing upper surface 601, and arranged beside the first button 62. The scroll wheel 64 is protruded out of the casing upper surface 601. By rotating the scroll wheel 64, a corresponding scrolling signal is generated. The first sensing element 65 is disposed on the casing upper surface 601, and arranged beside the first button 62. When the first sensing element 65 is triggered, a first sensing signal is generated. The second sensing element 66 is disposed on the casing lateral surface 602. When the second sensing element 66 is triggered, a second sensing signal is generated. In this embodiment, the first button 62 is a left button, and the second button 63 is a right button. Moreover, the first sensing element 65 and the second sensing element 66 are capacitive touch pads.

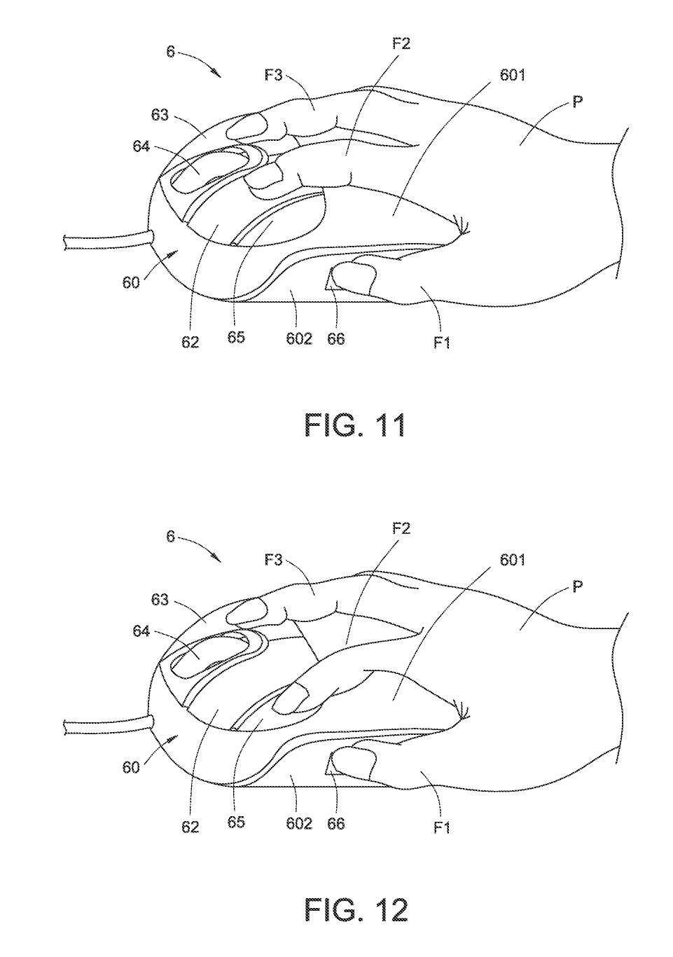

Like the multi-function mouse device 3 of the first embodiment, the multi-function mouse device 6 is also in communication with the computer system 4 for controlling movement of the cursor 421 shown on the computer monitor 42. For operating the computer system via the multi-function mouse device 6, the user's palm P is supported on the casing upper surface 601 of the casing 60. In addition, a first finger F1 is placed on the casing lateral surface 602 to trigger the second sensing element 66 on the casing lateral surface 602, a second finger F2 is placed on the first button 62 but is not contacted with the first sensing element 65 beside the first button 62, and a third finger F3 is placed on the second button 63 (see FIG. 11).

Since the second sensing element 66 is triggered by the first finger F1, a second sensing signal is issued to the controlling unit. In addition, when the casing 60 is moved by the user's palm P in a first linear direction (e.g. the first linear direction is a front direction), a frontward displacement amount signal is issued from the displacement sensing module to the controlling unit. When the second sensing signal and the displacement amount signal are received by the controlling unit, a frontward cursor displacement signal is issued from the controlling unit to the computer host 41. According to the frontward cursor displacement signal, the computer host 41 moves the cursor 421 in the front direction.

FIG. 12 is a schematic diagram illustrating the use of the multi-function mouse device of the third embodiment to generate a preset function signal. As shown in FIG. 12, the user's palm P is supported on the casing upper surface 601 of the casing 60. In addition, the first finger F1 is placed on the casing lateral surface 602 to trigger the second sensing element 66 on the casing lateral surface 602, the second finger F2 is placed on the first sensing element 65 beside the first button 62, and the third finger F3 is placed on the second button 63. Since the first sensing element 65 and the second sensing element 66 are respectively triggered by the second finger F2 and the first finger F1, a first sensing signal and a second sensing signal are issued to the controlling unit. In addition, when the casing 60 is moved by the user's palm P in the front direction, a frontward displacement amount signal is issued from the displacement sensing module to the controlling unit. When the first sensing signal, the second sensing signal and the displacement amount signal are received by the controlling unit, a frontward preset function signal is issued from the controlling unit to the computer host 41. According to the preset function signal, the computer host 41 executes a preset instruction. Like the first embodiment, the forward preset instruction is executed to implement the IE web browser opening function

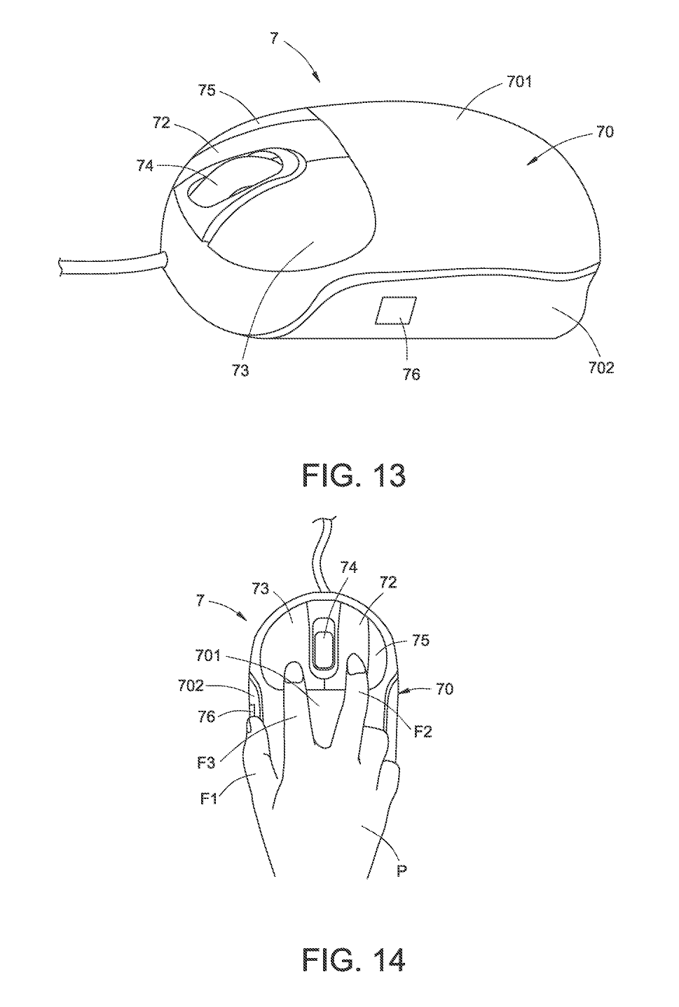

The present invention further provides a fourth exemplary multi-function mouse device. FIG. 13 is a schematic perspective view illustrating a multi-function mouse device according to a fourth embodiment of the present invention. The multi-function mouse device 7 comprises a casing 70, a displacement sensing module (not shown), a first button 72, a second button 73, a scroll wheel 74, a first sensing element 75, a second sensing element 76 and a controlling unit (not shown). The casing 70 has a casing upper surface 701 and a casing lateral surface 702. The first button 72 is disposed on the casing upper surface 701. The second button 73 is also disposed on the casing upper surface 701, and arranged beside the first button 72. The scroll wheel 74 is protruded out of the casing upper surface 701. By rotating the scroll wheel 74, a corresponding scrolling signal is generated. The first sensing element 75 is disposed on the casing upper surface 701, and arranged beside the first button 72. When the first sensing element 75 is triggered, a first sensing signal is generated. The second sensing element 76 is disposed on the casing lateral surface 702. When the second sensing element 76 is triggered, a second sensing signal is generated. In this embodiment, the first button 72 is a right button, and the second button 73 is a left button. Moreover, the first sensing element 75 and the second sensing element 76 are capacitive touch pads.

Like the multi-function mouse device 3 of the first embodiment, the multi-function mouse device 7 is also in communication with the computer system 4 for controlling movement of the cursor 421 shown on the computer monitor 42. For operating the computer system via the multi-function mouse device 7, the user's palm P is supported on the casing upper surface 701 of the casing 70. In addition, a first finger F1 is placed on the casing lateral surface 702 to trigger the second sensing element 76 on the casing lateral surface 702, a second finger F2 is placed on the first button 72 but is not contacted with the first sensing element 75 beside the first button 52, and a third finger F3 is placed on the second button 73 (see FIG. 14).

Since the second sensing element 76 is triggered by the first finger F1, a second sensing signal is issued to the controlling unit. In addition, when the casing 70 is moved by the user's palm P in a rear direction, a rearward displacement amount signal is issued from the displacement sensing module to the controlling unit. When the second sensing signal and the displacement amount signal are received by the controlling unit, a rearward preset function signal is issued from the controlling unit to the computer host 41. According to the rearward preset function signal, the computer host 41 executes a preset instruction. Like the first embodiment, the rearward preset instruction is executed to implement the frame-locking function.

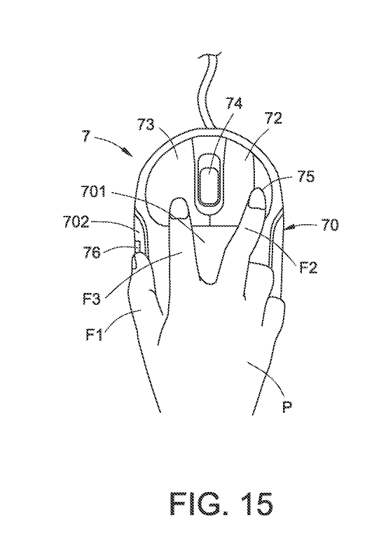

FIG. 15 is a schematic diagram illustrating the use of the multi-function mouse device of the fourth embodiment to generate a cursor displacement signal. As shown in FIG. 15, the user's palm P is supported on the casing upper surface 701 of the casing 70. In addition, the first finger F1 is placed on the casing lateral surface 702 to trigger the second sensing element 76 on the casing lateral surface 702, the third finger F3 is placed on the second button 73, and the second finger F2 is placed on the first sensing element 75 beside the first button 72 to trigger the first sensing element 75. Since the first sensing element 75 and the second sensing element 76 are respectively triggered by the second finger F2 and the first finger F1, a first sensing signal and a second sensing signal are issued to the controlling unit. In addition, when the casing 70 is moved by the user's palm P in a first linear direction (e.g. the first linear direction is a rear direction), a rearward displacement amount signal is issued from the displacement sensing module to the controlling unit. When the first sensing signal, the second sensing signal and the displacement amount signal are received by the controlling unit, a rearward cursor displacement signal is issued from the controlling unit to the computer host 41. According to the rearward cursor displacement signal, the computer host 41 moves the cursor 421 in the rear direction.

It is noted that various preset functions of the multi-function mouse device may be preset according to the practical requirements of different users. In the above embodiments, eight preset functions corresponding eight linear directions may be implemented according to various combinations of the first sensing signal, the second sensing signal and the displacement amount signal. Since the preset functions of the present invention restrictedly correspond to the eight linear directions, the data correlating the eight preset functions with the eight linear directions may occupy less bits of the memory. In other words, the data correlating the eight preset functions with the eight linear directions may be stored in the memory of the controlling unit. As a consequence, the multi-function mouse device of the present invention can implement various specified functions without the need of installing a driver in the computer host.

As known, when the casing of a mouse device is moved by the user, the casing usually fails to be precisely moved in the linear direction, and the casing is somewhat deviated from the linear direction. In accordance with the present invention, the displacement amount of moving the casing is analyzed by the controlling unit of the multi-function mouse device so as to obtain a horizontal displacement component and a vertical displacement component. According to the proportion between the horizontal displacement component and the vertical displacement component, the controlling unit may realize which direction corresponds to the displacement amount. For example, if the rightward horizontal displacement component of a displacement amount is 100 mm and the frontward vertical displacement component is 5 mm, the controlling unit will judge that the displacement amount is 100 mm in the right direction while neglecting the frontward vertical displacement component (5 mm). In this situation, the possibility of erroneously operating the multi-function mouse device from moving deviation will be minimized.

From the above description, the multi-function mouse device of the present invention is capable of implementing various specified functions without the need of installing a driver. In addition, the memory of the controlling unit only needs to store the data correlating the preset functions with the corresponding moving directions. According to the signals from the first sensing element, the second sensing element and the displacement sensing module, the controlling unit may realize what instruction is inputted via the multi-function mouse device, and then execute the specified instruction. Moreover, in the above drawings, the multi-function mouse device of the present invention is illustrated by referring to a wired mouse device. Nevertheless, the concepts of the multi-function mouse device of the present invention may be applied to a wired mouse device or a wireless mouse device. In comparison with the conventional mouse device, the multi-function mouse device of the present invention provides various functions without the need of installing a driver. In other words, the multi-function mouse device of the present invention is more user-friendly.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A multi-function mouse device in communication with a computer host for controlling a cursor shown on a computer monitor, said computer monitor being in communication with said computer host, said multi-function mouse device comprising:
a casing having a casing upper surface and a casing lateral surface;
a displacement sensing module disposed within said casing, wherein said displacement sensing module generates a displacement amount signal in response to movement of said casing;
a first button disposed on said casing upper surface;
a second button disposed on said casing upper surface, and arranged beside said first button;
a first sensing element disposed on said first button, wherein when said first sensing element is triggered, a first sensing signal is generated;
a second sensing element disposed on said casing lateral surface, wherein when said second sensing element is triggered, a second sensing signal is generated; and
a controlling unit connected with said first sensing element, said second sensing element and said displacement sensing module for receiving said first sensing signal, said second sensing signal and said displacement amount signal, wherein when said second sensing signal and said displacement amount signal are received by said controlling unit, a cursor displacement signal is issued from said controlling unit to said computer host, and said computer host moves said cursor according to said cursor displacement signal, wherein when said first sensing signal, said second sensing signal and said displacement amount signal are received by said controlling unit, a preset function signal is issued from said controlling unit to said computer host, and said computer host executes a preset instruction according to said preset function signal.

2. The multi-function mouse device according to claim 1 further comprising a scroll wheel protruded out of said casing upper surface, wherein a scrolling signal is generated when said scroll wheel is rotated.

3. The multi-function mouse device according to claim 1 wherein said first button is a left button, said second button is a right button, and said first sensing element and said second sensing element are light sensors or capacitive touch pads.

4. The multi-function mouse device according to claim 1 wherein when said casing is moved in a first linear direction, said displacement sensing module generates said displacement amount signal corresponding to said first linear direction, wherein according to said displacement amount signal corresponding to said first linear direction, said cursor displacement signal corresponding to said first linear direction is issued from said controlling unit, and said computer host moves said cursor in said first linear direction or executes said preset instruction corresponding to said first linear direction, wherein said preset instruction corresponding to said first linear direction is executed to implement an IE web browser opening function, an IE software “Backward” function, an IE software “Forward” function or a frame-locking function.

5. A multi-function mouse device in communication with a computer host for controlling a cursor shown on a computer monitor, said computer monitor being in communication with said computer host, said multi-function mouse device comprising:
a casing having a casing upper surface and a casing lateral surface;
a displacement sensing module disposed within said casing, wherein said displacement sensing module generates a displacement amount signal in response to movement of said casing;
a first button disposed on said casing upper surface;
a second button disposed on said casing upper surface, and arranged beside said first button;
a first sensing element disposed on said first button, wherein when said first sensing element is triggered, a first sensing signal is generated;
a second sensing element disposed on said casing lateral surface, wherein when said second sensing element is triggered, a second sensing signal is generated; and
a controlling unit connected with said first sensing element, said second sensing element and said displacement sensing module for receiving said first sensing signal, said second sensing signal and said displacement amount signal, wherein when said first sensing signal, said second sensing signal and said displacement amount signal are received by said controlling unit, a cursor displacement signal is issued from said controlling unit to said computer host, and said computer host moves said cursor according to said cursor displacement signal, wherein when said second sensing signal and said displacement amount signal are received by said controlling unit, a preset function signal is issued from said controlling unit to said computer host, and said computer host executes a preset instruction according to said preset function signal.

6. The multi-function mouse device according to claim 5 wherein said first button is a right button, said second button is a left button, and said first sensing element and said second sensing element are light sensors or capacitive touch pads.

7. The multi-function mouse device according to claim 5 wherein when said casing is moved in a first linear direction, said displacement sensing module generates said displacement amount signal corresponding to said first linear direction, wherein according to said displacement amount signal corresponding to said first linear direction, said cursor displacement signal corresponding to said first linear direction is issued from said controlling unit, and said computer host moves said cursor in said first linear direction or executes said preset instruction corresponding to said first linear direction, wherein said preset instruction corresponding to said first linear direction is executed to implement an IE web browser opening function, an IE software “Backward” function, an IE software “Forward” function or a frame-locking function.

8. A multi-function mouse device in communication with a computer host for controlling a cursor shown on a computer monitor, said computer monitor being in communication with said computer host, said multi-function mouse device comprising:
a casing having a casing upper surface and a casing lateral surface;
a displacement sensing module disposed within said casing, wherein said displacement sensing module generates a displacement amount signal in response to movement of said casing;
a first button disposed on said casing upper surface;
a second button disposed on said casing upper surface, and arranged beside said first button;
a first sensing element disposed on said first button, and arranged beside said first button, wherein when said first sensing element is triggered, a first sensing signal is generated;
a second sensing element disposed on said casing lateral surface, wherein when said second sensing element is triggered, a second sensing signal is generated; and
a controlling unit connected with said first sensing element, said second sensing element and said displacement sensing module for receiving said first sensing signal, said second sensing signal and said displacement amount signal, wherein when said second sensing signal and said displacement amount signal are received by said controlling unit, a cursor displacement signal is issued from said controlling unit to said computer host, and said computer host moves said cursor according to said cursor displacement signal, wherein when said first sensing signal, said second sensing signal and said displacement amount signal are received by said controlling unit, a preset function signal is issued from said controlling unit to said computer host, and said computer host executes a preset instruction according to said preset function signal.

9. The multi-function mouse device according to claim 8 wherein said first button is a left button, said second button is a right button, and said first sensing element and said second sensing element are light sensors or capacitive touch pads.

10. The multi-function mouse device according to claim 8 wherein when said casing is moved in a first linear direction, said displacement sensing module generates said displacement amount signal corresponding to said first linear direction, wherein according to said displacement amount signal corresponding to said first linear direction, said cursor displacement signal corresponding to said first linear direction is issued from said controlling unit, and said computer host moves said cursor in said first linear direction or executes said preset instruction corresponding to said first linear direction, wherein said preset instruction corresponding to said first linear direction is executed to implement an IE web browser opening function, an IE software “Backward” function, an IE software “Forward” function or a frame-locking function.

11. A multi-function mouse device in communication with a computer host for controlling a cursor shown on a computer monitor, said computer monitor being in communication with said computer host, said multi-function mouse device comprising:
a casing having a casing upper surface and a casing lateral surface;
a displacement sensing module disposed within said casing, wherein said displacement sensing module generates a displacement amount signal in response to movement of said casing;
a first button disposed on said casing upper surface;
a second button disposed on said casing upper surface, and arranged beside said first button;
a first sensing element disposed on said first button, and arranged beside said first button, wherein when said first sensing element is triggered, a first sensing signal is generated;
a second sensing element disposed on said casing lateral surface, wherein when said second sensing element is triggered, a second sensing signal is generated; and
a controlling unit connected with said first sensing element, said second sensing element and said displacement sensing module for receiving said first sensing signal, said second sensing signal and said displacement amount signal, wherein when said first sensing signal, said second sensing signal and said displacement amount signal are received by said controlling unit, a cursor displacement signal is issued from said controlling unit to said computer host, and said computer host moves said cursor according to said cursor displacement signal, wherein when said second sensing signal and said displacement amount signal are received by said controlling unit, a preset function signal is issued from said controlling unit to said computer host, and said computer host executes a preset instruction according to said preset function signal.

12. The multi-function mouse device according to claim 11 wherein said first button is a right button, said second button is a left button, and said first sensing element and said second sensing element are light sensors or capacitive touch pads.

13. The multi-function mouse device according to claim 11 wherein when said casing is moved in a first linear direction, said displacement sensing module generates said displacement amount signal corresponding to said first linear direction, wherein according to said displacement amount signal corresponding to said first linear direction, said cursor displacement signal corresponding to said first linear direction is issued from said controlling unit, and said computer host moves said cursor in said first linear direction or executes said preset instruction corresponding to said first linear direction, wherein said preset instruction corresponding to said first linear direction is executed to implement an IE web browser opening function, an IE software “Backward” function, an IE software “Forward” function or a frame-locking function.
